(19) United States
(12) Patent Application Publication
(10) Pub. No.: US 2023/0019721 A1
(43) Pub. Date: Jan. 19, 2023

(54) System and Method for Facilitating Trespass Incident Reporting

(71) Applicant: BlueWave Technology, Inc., Tulsa, OK (US)

(72) Inventor: Don Leslie Carr, JR., Bonney Lake, WA (US)

(21) Appl. No.: 17/955,158

(22) Filed: Sep. 28, 2022

Related U.S. Application Data
(63) Continuation-in-part of application No. 17/557,919, filed on Dec. 21, 2021.
(60) Provisional application No. 63/178,435, filed on Apr. 22, 2021.

(51) Int. Cl. G06V 20/52; G06V 40/16; G08B 21/22

(52) U.S. Cl. CPC G06V 20/52; G06V 40/168; G08B 21/22; G06V 2201/07

(57) ABSTRACT

A system and method to facilitate trespass incident reporting. The system includes a camera, a processor, a communication device, a remote server, a storage device, and a user personal computing (PC) device. The processor aids in identifying a trespasser using the facial images acquired by the camera through a visual comparison with known trespassers. The processor sends the acquired facial images to the remote server through the communication device. Then the acquired facial images are matched with images of trespassers in a trespasser database stored on the storage device. When no match is found, the remote server prompts the user's PC device to enter information for the first-time trespasser, and to present an audio no-trespass warning message to the trespasser while concurrently recording the presentation using an audio/video recorder. With the no-trespass recording, a trespasser incident report is created and distributed to all users.

### FIELD OF THE INVENTION

The present invention relates generally to security access systems and methods. More specifically, the present invention relates a system and method for a mobile application that allows the user to record a trespass incident and recognize past violators.

### BACKGROUND OF THE INVENTION

Trespassing is when a trespasser intentionally enters, without authorization, a predefined boundary of property legally occupied by a user or owner after the trespasser has been told not to enter. Often, the trespasser refuses to leave after being told to leave, and/or disturbs domestic animals and residents on the property, e.g., a farm, a house, a gated community, etc. Normally, a trespass notice can serve as a warning telling the trespasser to stay off the property. Additionally, the trespass notice can be given verbally and/or by giving or sending the trespasser a written trespass notice or report. In many states of the United States, if the trespasser served with a trespass notice comes back onto the property within the two years, the trespasser would be breaking the law and may be reported to the law enforcement.

In many states, laws require that there be a no-trespass warning and evidence of such a warning be giving to the trespasser before the trespass can be convicted for trespassing on the property. The user or owner of the property may bring a civil lawsuit against or even criminal charges to the trespasser in order to recover actual damages or receive compensatory relief for injury suffered as a direct result of the trespass. However, in many cases, a trespasser is verbally trespassed, but there is no written notice or record in detail for the trespass incident. Most existing security officers and/or guards may document trespass incidents in a daily log, which may lack of details, recording of no-trespass warning being given to the trespasser, intention of entry, authorization information, first-time trespasser, return trespasser, etc.

Similarly, retail crime and shoplifting often occur in patterns, with numerous incidents involving the same shoplifter or the same store. Incident logs of such retail crime incidents often fail to include various information about the incident that may allow security officers to better prevent similar incidents in the future.

Thus, it is the objective of the present invention to provide a unique and innovative solution to the aforementioned problems, issues, and disadvantages associated with trespass incident reporting. The system and method of the present invention facilitates the trespass incident reporting through an online platform to execute and record every detail of the efficient and effective process.

### SUMMARY OF THE INVENTION

The present invention, named “SafeScope,” comprises a system and method for facilitating effective and efficient trespass incident reporting. The system includes a camera, a processor, a communication device, a remote server, a storage device, and corresponding personal computing (PC) devices of user accounts. Each user account is associated with a property having a predefined boundary. The processor is configured to determine if a trespasser is identified using uploaded images and other trespasser information. A user may compare previous photos and trespasser information to the current incident to determine if there is a matching trespasser Once no match is found, the processor sends the property information, user information, and other acquired images and information to the remote server through the communication device, wherein the acquired images and information are matched with all images and information of trespassers in a trespasser database stored in the storage device. When there is no match found, the remote server prompts the PC device of the user to enter information for the new or first-time trespasser. Once the trespasser information is received, the remote server prompts the user's PC device to present an audio no-trespass warning message to the trespasser and at the same time record the presentation using an audio/video recorder. The user's PC device is allowed to enter additional information including, but not limited to, notes, comments, audio/video recordings, etc., and send the additional information together with the audio/video record of the no-trespass recording to the remote server. Consequently, the remote server creates a trespasser incident report that includes the property information, user information, trespasser information, acquire facial images of the trespasser, no-trespass warning audio/video recording and any additional information. Further, the remote server saves the trespasser incident report database and distributes the trespasser incident report to the corresponding PC devices of all user accounts that the remote server provides and manages.

When a match of the trespasser's acquire images is found in the trespasser database, the remote server displays on the user's PC device the information and all available trespass incident reports of the trespasser. Subsequently, the remote server prompts the user's PC device to present the no-trespass warning message to the trespasser and record the presentation at the same time. Additionally, the remote server adds the trespasser to a be-on-the-look-out (BOLO) list and distributes the BOLO list to the corresponding PC devices of all user accounts of the system. Further, the remote server allows the user's PC device to update the user allowed person saved in a user allowed person database that is stored on the storage device. The remote server also updates the trespasser database in a predefined frequency using internal and/or external databases/data sources. Thus, the system and method of the present invention offers the user an efficient and effective solution to reporting trespass incident and recognizing past violators of the user's property.

### BRIEF DESCRIPTION OF THE DRAWINGS

FIG. 1 is a block diagram of an online platform for facilitating trespass incident reporting of the present invention.

FIG. 2 is a block diagram of a system for facilitating trespass incident reporting of the present invention.

FIG. 3 is a flowchart of a method for facilitating trespass incident reporting of the present invention, in accordance with some embodiments.

FIG. 4 is a flowchart of a subprocess for trespasser identification of the method for facilitating trespass incident reporting of the present invention.

FIG. 5 is a flowchart of an alternative embodiment of the subprocess for trespasser identification of the method for facilitating trespass incident reporting of the present invention, wherein at least one image of a trespasser is compared with at least one image of at least one user allowed person for a property.

FIG. 6 is a flowchart of another embodiment of the subprocess for trespasser identification of the method for facilitating trespass incident reporting of the present invention, wherein information and images of the at least one user is updated.

FIG. 7 is a flowchart of a sub-process of the method of the present invention, wherein a trespasser database is updated per a predefined frequency.

FIG. 8 is a flowchart of an alternative embodiment of the method of the present invention, wherein at least one previous trespass incident report of the trespasser is displayed on the corresponding person computing (PC) device of a user of the property.

FIG. 9 is a flowchart of another embodiment of the method of the present invention, wherein a plurality of user accounts is provided by a remote server of the present invention.

FIG. 10 is a flowchart of another embodiment of the method of the present invention, wherein a be-on-the-look-out (BOLO) list including the trespasser is distributed to the corresponding PC device of the plurality of user accounts.

FIG. 11 is a flowchart of another embodiment of the method of the present invention, wherein a trespass incident report is distributed to the corresponding PC device of the plurality of user accounts.

FIG. 12 is a flowchart of another embodiment of the method of the present invention, wherein a least one note is added to the trespass incident report.

FIG. 13 is a block diagram of a computing device for implementing the method of the present invention, in accordance with some embodiments.

FIG. 14 is an illustration of an explementary embodiment of the method of the present invention, wherein a step 1 is provided.

FIG. 15 is an illustration of the explementary embodiment of the method of the present invention, wherein a step 2 is provided.

FIG. 16 is an illustration of the explementary embodiment of the method of the present invention, wherein a step 3 is provided.

FIG. 17 is an illustration of the explementary embodiment of the method of the present invention, wherein a step 4 is provided.

FIG. 18 is an illustration of the explementary embodiment of the method of the present invention, wherein a step 5 is provided.

FIG. 19 is an illustration of the explementary embodiment of the method of the present invention, wherein a step 6 is provided.

FIG. 20 is an illustration of the explementary embodiment of the method of the present invention, wherein a step 7 is provided.

FIG. 21 is an illustration of the explementary embodiment of the method of the present invention, wherein a step 8 is provided.

FIG. 22 is an illustration of the explementary embodiment of the method of the present invention, wherein a step 9 is provided.

FIG. 23 is an illustration of the explementary embodiment of the method of the present invention, wherein a step 10 is provided.

### DETAIL DESCRIPTIONS OF THE INVENTION

All illustrations of the drawings are for the purpose of describing selected versions of the present invention and are not intended to limit the scope of the present invention.

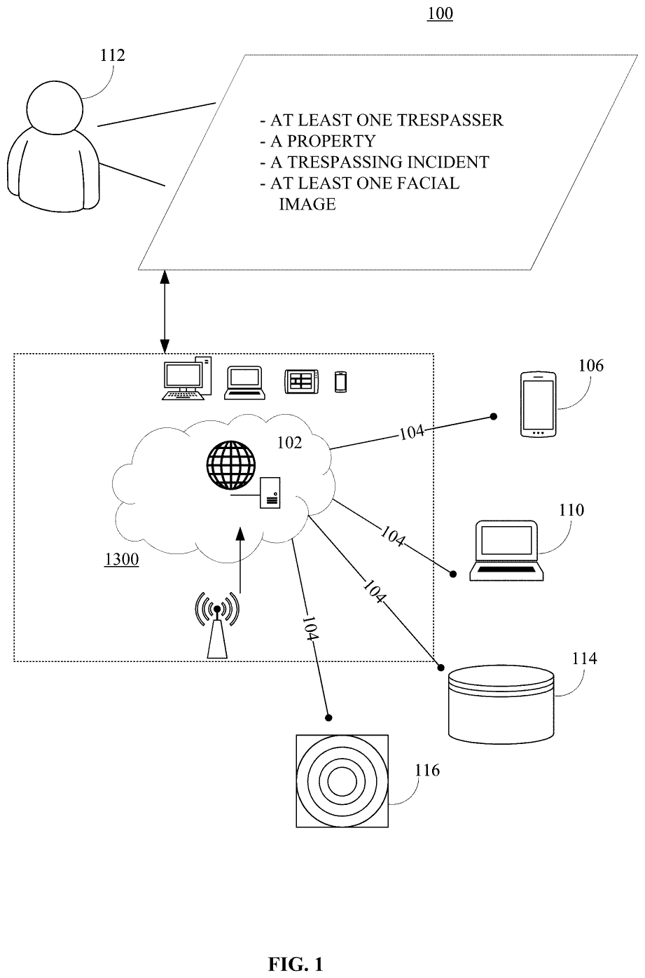

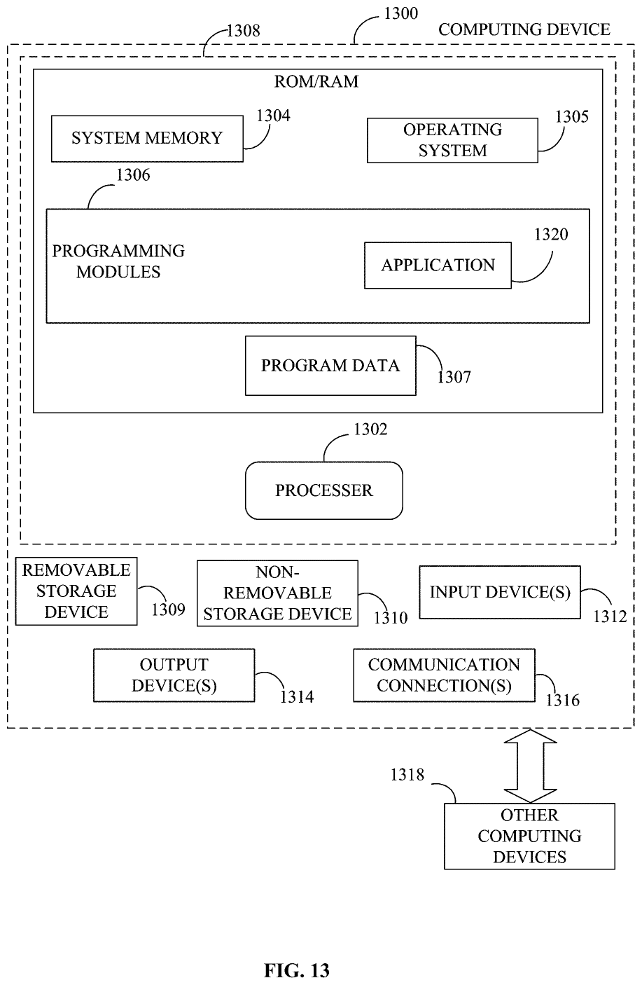

As can be seen in FIG. 1, an online platform 100 consistent with various embodiments of the present invention, named “SafeScope,” facilitates a system and method for trespass incident reporting may be hosted on a remote server 102, such as, for example, a cloud computing service 1300, as can be seen in FIG. 13. The remote server 102 may communicate with other network entities, including, but not limited to, a mobile device 106 (such as a smartphone, a laptop, a tablet computer, etc.), other electronic devices 110 (such as desktop computers, server computers, etc.), databases 114, sensors 116, and actuators (not shown) over a communication network 104, including, but not limited to, the Internet. A user 112 of the online platform 100 may include relevant parties including, but not limited to, end-user, administrator, service provider, service consumer, security professional, security guard, law enforcement personal, officer, and so on. Accordingly, in some embodiments, electronic devices operated by the one or more relevant parties may be in communication with the online platform 100. The user 112, such as the one or more relevant parties, may access the online platform 100 through a web-based software application, application programming interface (API), or browser. The web-based software application may be embodied as, for example, but not be limited to, a website, a web application, a desktop application, and a mobile application compatible with a computing device 1300.

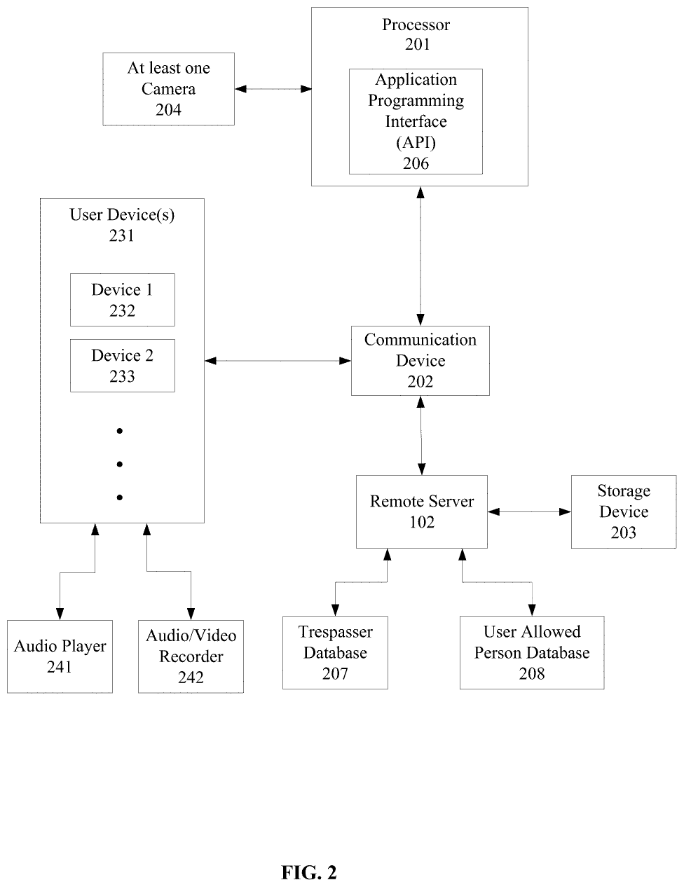

As can be seen in FIG. 2, an online system for facilitating trespass incident reporting of the present invention, in accordance with some embodiments, may include a processor 201, a communication device 202, the remote server 102, a storage device 203, a camera 204, a trespasser database 207, a user allowed person database 208, and at least one user device 231. The processor 201 may comprise at least one application programming interface (API) 206.

The communication device 202 may be communicatively coupled with the processor 201 and may be configured for transmitting at least one image of the trespasser between the processer 201 and the user device 231. The at least one user device 231 may be associated with at least one user account managed by the remote server 102. The remote server 102 may send prompts to and receive user entered information from the user device 231. The user entered information may include, but is not limited to, a full name, a date of birth, a driver's license number, images, video, and/or any other relevant information of the trespasser, address of the user's property, GPS (global positioning system) coordinates of the property, property description, trespass incident description, notes, date, time, etc. The at least one user device 231 may include devices such as, but is not limited to, smartphones, laptops, PCs, etc. The communication device 202 may be configured for transmitting the images of the trespasser to the remote server 102 and transmitting the trespass incident report generated by the remote server 102 to the corresponding user device 231, and/or any other PC (personal computing) device of the plurality of user accounts.

As can be seen in FIG. 2, the remote server 102 may be coupled with the storage device 203. The remote server 102 may be configured for saving the personal information and images of the trespasser into the trespasser database 207, wherein the trespasser database 207 is saved on the storage device 203. Additionally, the remote server 102 is configured to save the custom information including, but not limited to, additional notes associated with the trespasser and/or the trespass incident received from the user device 231. The remote server 102 may provide the user allowed person database 208 to the plurality of user accounts, wherein the user allowed person database 208 may include at least one user allowed for the property, including, but not limited to, owner of the property, any person the user allows for access to and/or occupying the property, such as family member, friend, relative, etc. Further, the remote server 102 may be configured for allowing the plurality of user accounts to update the information associated with at least one user allowed person through the corresponding user device 231 and saving the updated information in the user allowed person database 208.

As can be seen in FIG. 2, the storage device 203 may be communicatively coupled with the remote server 102. Additionally, the storage device 203 may be configured for storing the trespasser database 207 and the user allowed person database 208. Further, the remote server 102 updates the trespasser database 207 using internal and external databases and/or data sources. The remote server 102 also updates the user allowed person database 208 through the corresponding PC device 231 of the plurality of user accounts. The remote server 102 stores the most current trespasser database 207 user allowed person database 208 on the storage device 203.

The API 206 may comprise software instructions, when actuated, causing the processor 201 to perform operations of the method, including, but not limited to, the communication with at least one camera 204, the at least one PC device 231 and the remote server 102 through the communication device 202, etc. Specifically, the processor 201 may be configured for aiding in determining if a trespasser on a user's property with a predefined boundary is identified 205 when the at least one trespasser image and/or the at least one trespasser information acquired by the at least one camera 204 is compared with the at least one trespasser image of the at least one user allowed person for the property and a match is found. The at least one image and/or the at least one trespasser information may be manually linked by comparing the image and/or information to images and information for the at least one allowed person for the property. Once comparison of the at least one image of the trespasser with all available data for user allowed persons is completed and no match is found, the processor 201 sends the at least one trespasser image acquired by the at least one camera 204 to the remote server 102 through the communication device 202. The remote server 102 then aids in comparing the image and trespasser information of the trespasser with all trespassers in the trespasser database 207 by providing comparison images and information to be manually compared by the user with the at least one PC device 231. The remote server 102 may prompt the at least one PC device 231 to indicate whether or not a match has been found. When no match is found, the remote server 102 prompts the PC device 231 of the user through the communication device 202 to enter specific information for this new or first-time trespasser. Once the trespasser information is received through the communication device 202, the remote server 102 saves the trespasser information and the at least one trespasser image to the trespasser database 207. Consequently, the remote server 102 prompts the PC device 231 of the user to record, using an audio player to present an audio no-trespass warning message to the trespasser and at the same time record the presentation, using an audio/video recorder. After presentation, the recording is transmitted through the communication device 202 to the remote server 102 from the PC device 231 of the user Additionally, the processor 201 may be configured for generating at least one smart. The user's PC device is allowed to transmit any relevant information and/or recordings to the remote server 102. The remote server 102 then uses the recording, trespasser information, trespasser's image, property information, etc., and creates a trespass incident report. The trespass incident report is saved to the trespasser database 207 and distributed to the PC device 231 of the plurality of user accounts managed by the remote server 102, through the communication device 202. In cases where the trespass is discovered via security footage, a no-trespass warning message may not be prompted.

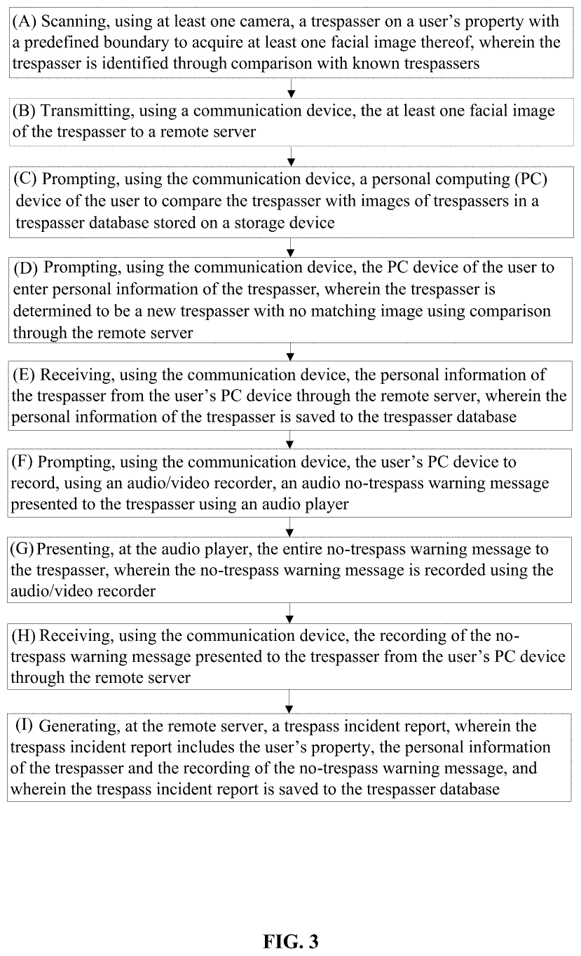

As can be seen in FIG. 3, the method for facilitating the trespass incident reporting of the present invention includes a step of scanning, using at least one camera 204, a trespasser on a user's property with a predefined boundary to acquire at least one trespasser image thereof, wherein the trespasser is identified through a processor 201 manual comparison of the image with images and information of known trespassers (Step A). The at least one camera 204 may include, but is not limited to, a security camera, a surveillance camera, a 360-degree camera, a smartphone camera, a video camera, a camcorder, a digital camcorder, and any other suitable camera. Additionally, the method transmits, using a communication device 202, the at least one trespasser image of the trespasser to a remote server 102, at which point the at least one trespasser image is compared with a plurality of images of trespassers in a trespasser database 207 stored on a storage device 203 (Step C). In Step C, the same manual comparison is used for the comparison of the at least one trespasser image of the trespasser with the plurality of facial images of trespassers in the trespasser database 207.

Subsequently, the method prompts, using the communication device 202, a personal computing (PC) device 231 of the user to enter personal information of the trespasser, wherein the trespasser is determined to be a new trespasser with no matching trespasser in a trespasser database 207 stored on a storage device 203 (Step D). Additionally, the method receives, using the communication device 202, the personal information of the trespasser from the user's PC device 231 through the remote server 102, wherein the personal information of the trespasser is saved to the trespasser database 207 (Step E). In response to a new trespasser to the user's property, the method interacts with the corresponding PC device 231 of the user to add any relevant information of the trespasser and the at least one trespasser image of the trespasser to the trespasser database 207. The relevant personal information of the trespasser includes, but is not limited to, first name, last name, gender, date of birth, home address, profession, driver's license number, sate issuing the driver's license, etc.

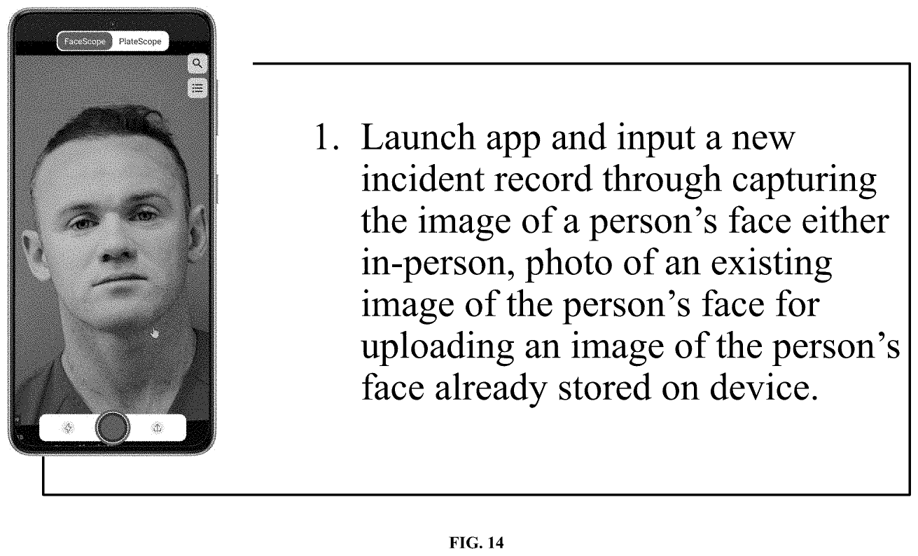

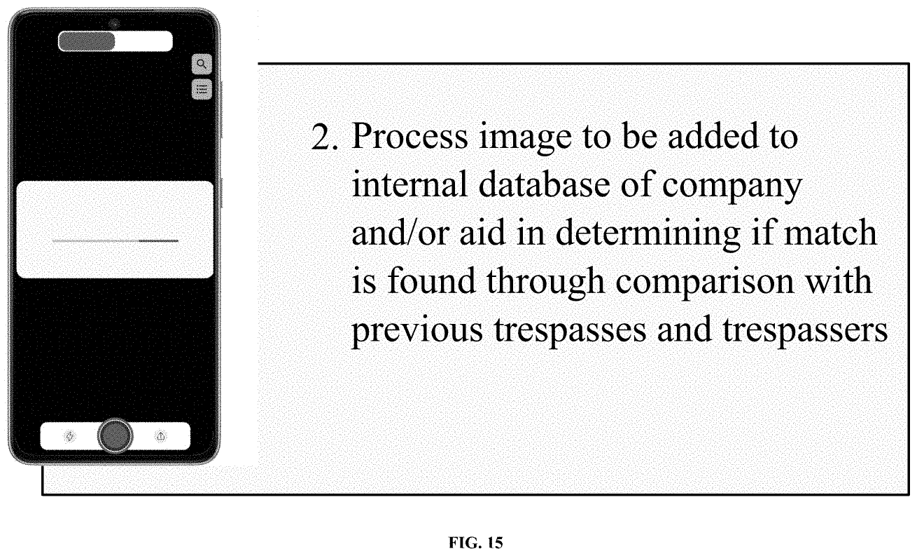

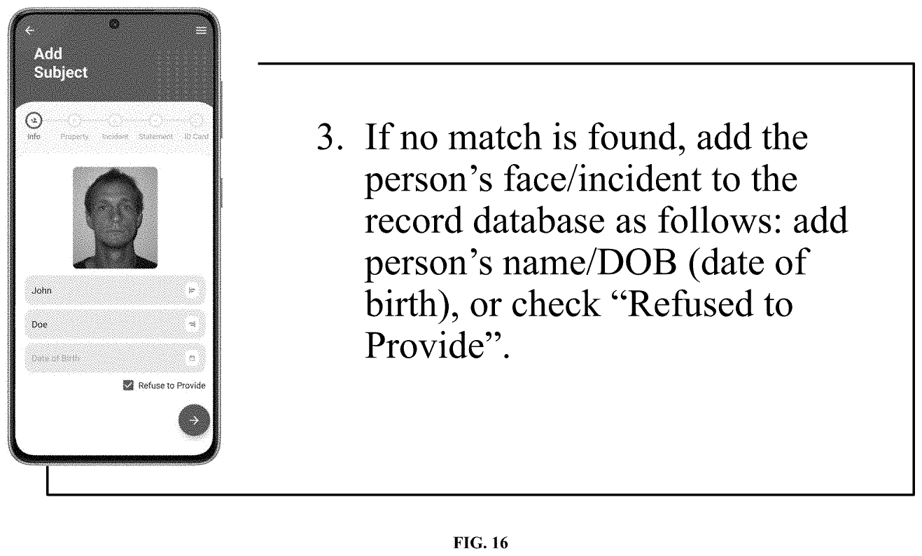

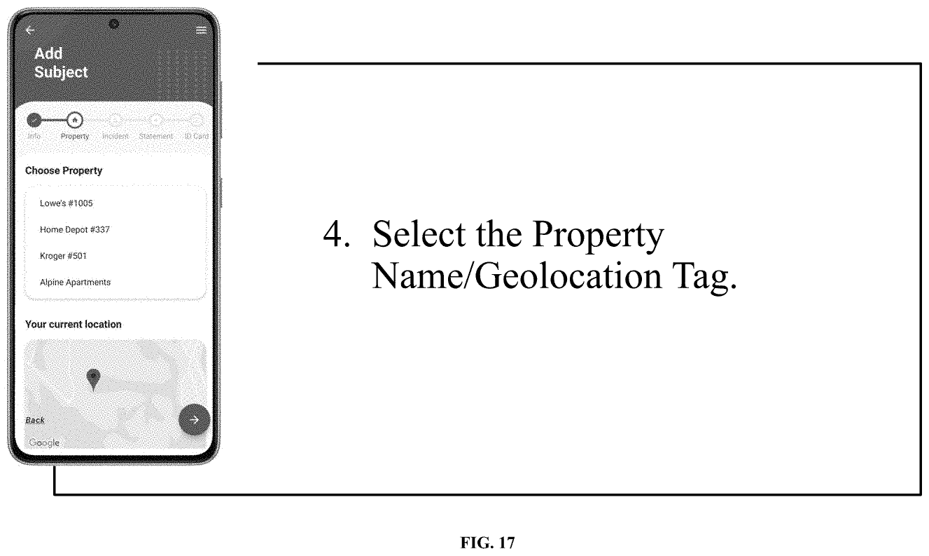

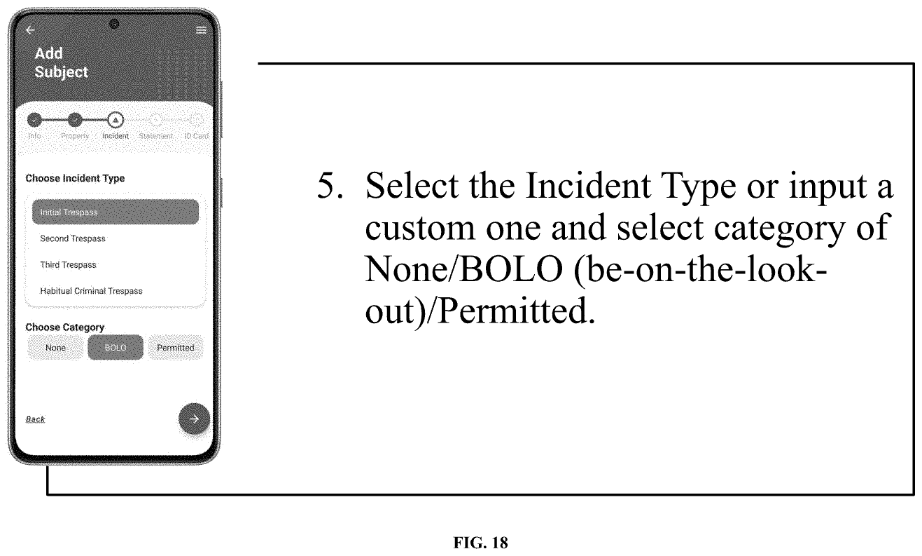

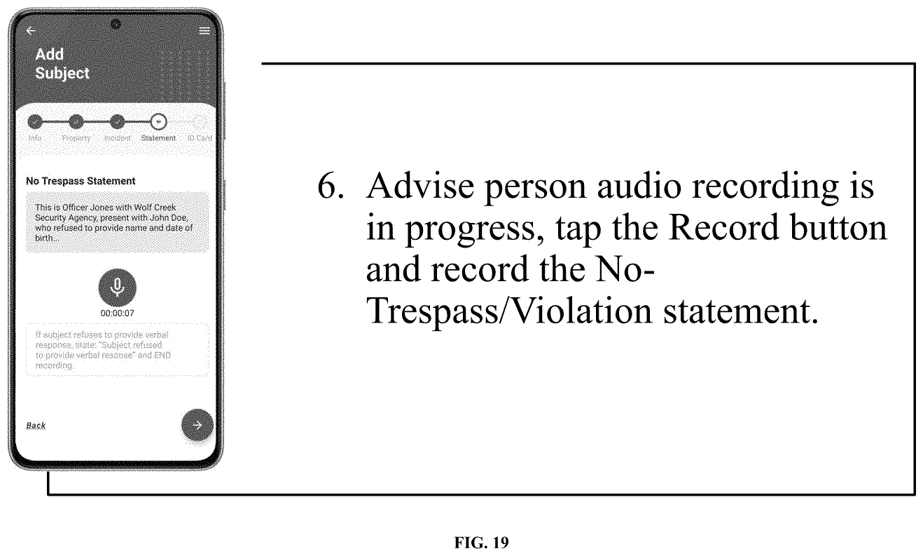

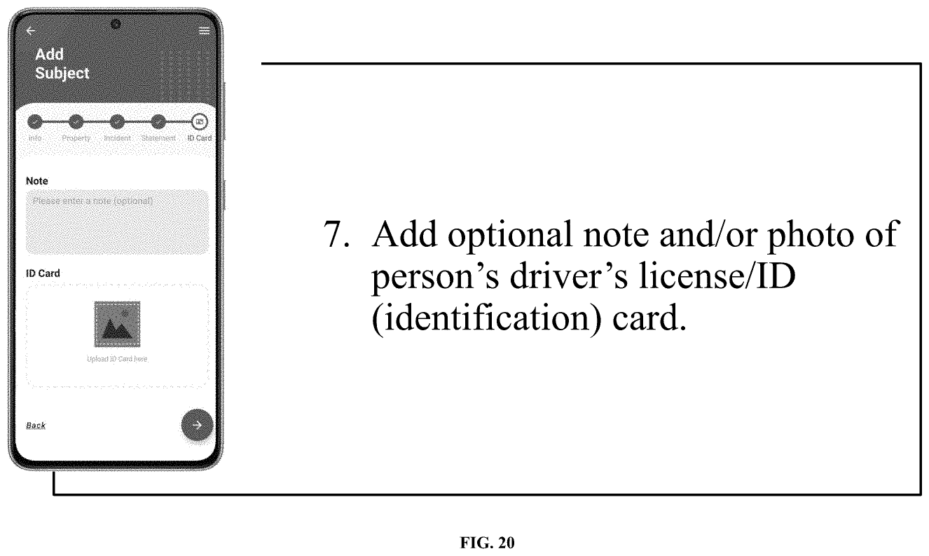

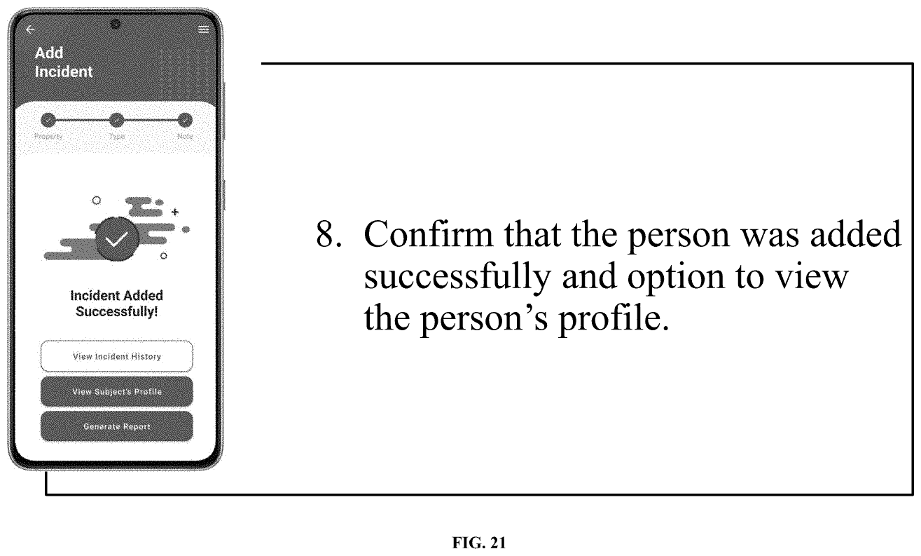

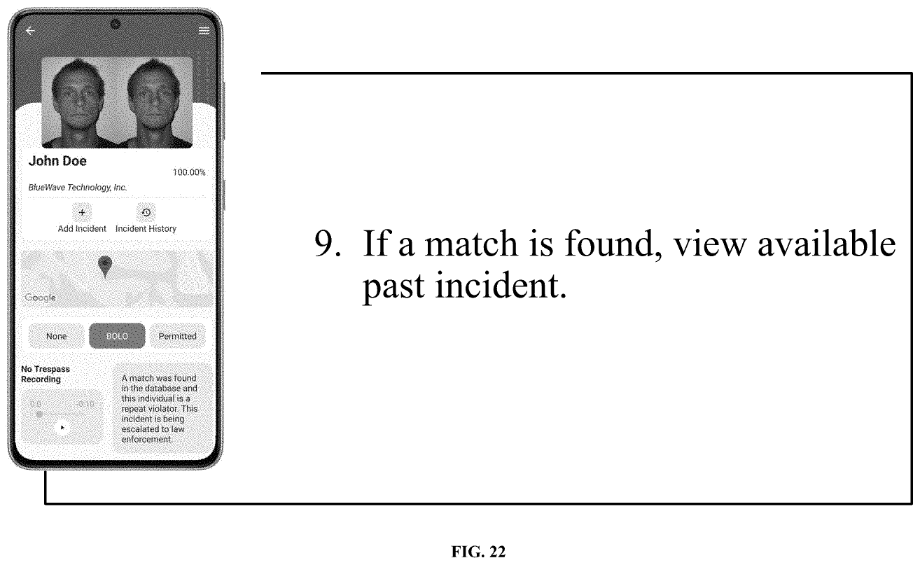

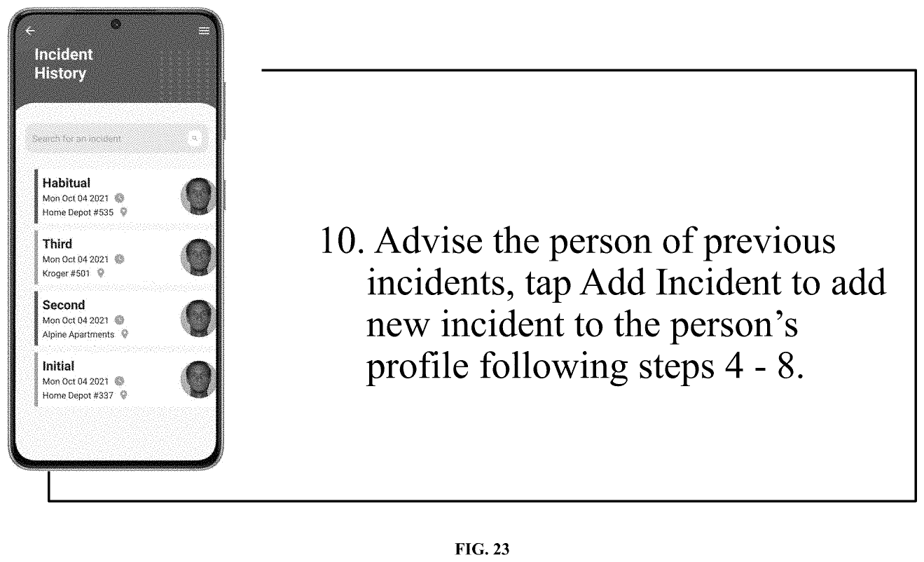

Upon the identification of the trespasser, the method prompts, using the communication device 202, the user's PC device 231 to record, using an audio/video recorder 242, an audio no-trespass warning message presented to the trespasser using an audio player 241 (Step F). Additionally, the method presents, at the audio player 241, the entire no-trespass warning message to the trespasser, wherein the no-trespass warning message is recorded using the audio/video recorder 242 (Step G). Further, the method receives, using the communication device 202, the recording of the no-trespass warning message presented to the trespasser from the user's PC device 231 through the remote server 102 (Step H). The recoding may include other audio and/or video recording of the presentation of the no-trespass warning message, any other relevant recording, etc. Both the audio player 241 and the audio/video recorder 242 are connected to the corresponding PC device 231 of the user. Subsequently, the method generates, at the remote server 102, a trespass incident report, wherein the trespass incident report includes the user's property, the personal information of the trespasser and the recording of the no-trespass warning message, and wherein the trespass incident report is saved to the trespasser database 207 (Step I). Additionally, the trespass incident report is distributed to the PC devices of the plurality of user accounts managed by the remote server 102, using the communication device 202. Further, the at least one image of the trespasser may comprise a video recording. An explementary embodiment of the present invention can be seen in FIG. 14 to FIG. 23.

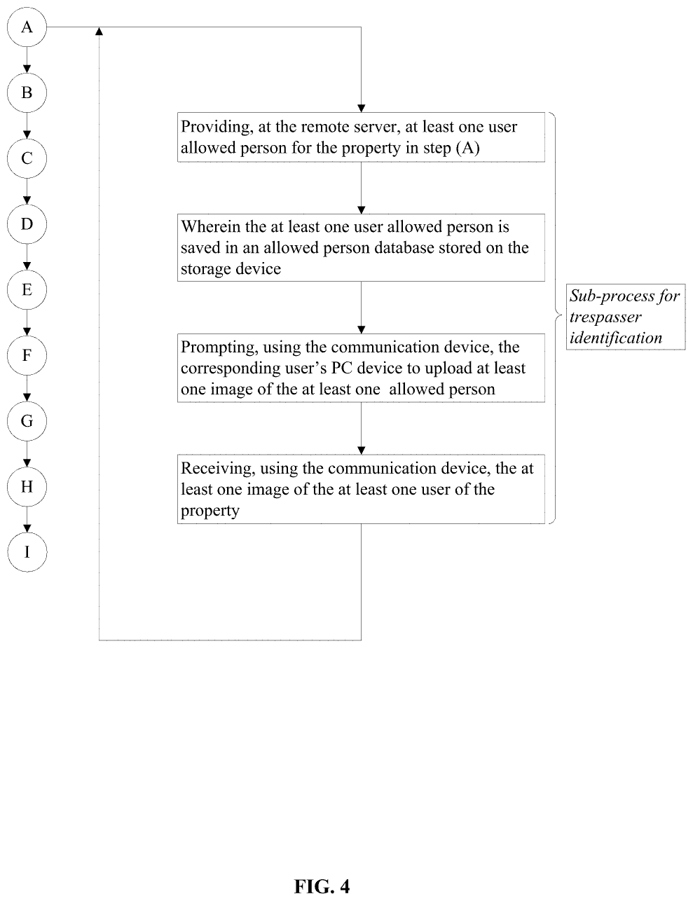

As can be seen in FIG. 4, the method of the present invention provides a subprocess for trespasser identification. Specifically, the method providing, at the remote server, at least one user allowed person for the property in Step A, wherein the at least one user allowed person is saved in an allowed person database stored on the storage device 203. Subsequently, the method prompts, using the communication device 202, the corresponding user's PC device 231 to upload at least one image of the at least one user allowed person, and receives, using the communication device 202, the at least one image of the at least one user allowed person of the property.

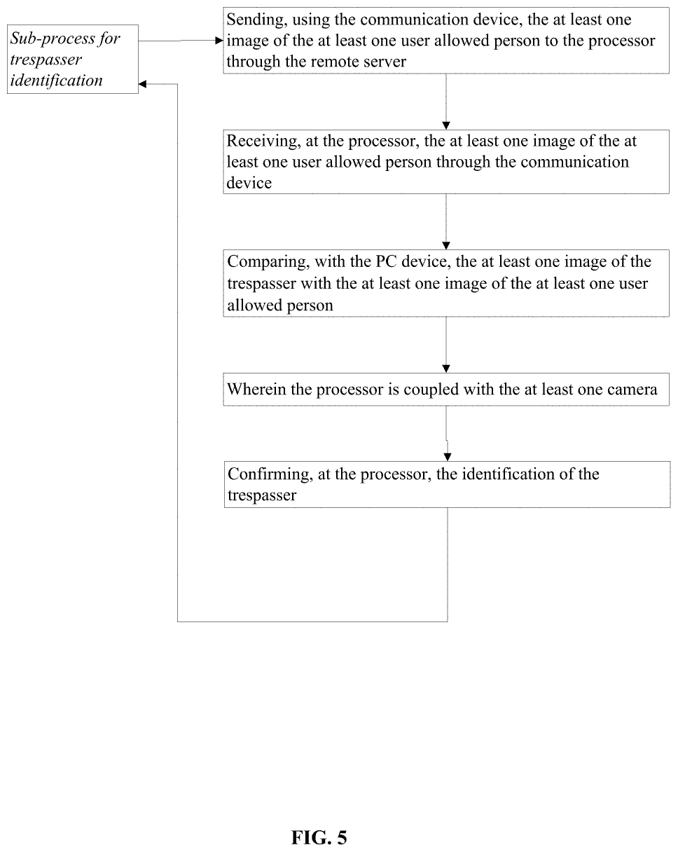

As can be seen in FIG. 5, in an alternative embodiment of the present invention, the method sends, using the communication device 202, the at least one image of the at least one user allowed person to the processor 201 through the remote server 102, and receives, at the processor 201, the at least one image of the at least one user allowed person through the communication device 202. Subsequently, the method prompts, using the communication device 202, the user's PC device 231 to compare the at least one image of the trespasser with the at least one image of the at least one user allowed person, wherein the processor 201 is coupled with the at least one camera 204. Then, the method confirms, at the processor 201, the identification of the trespasser.

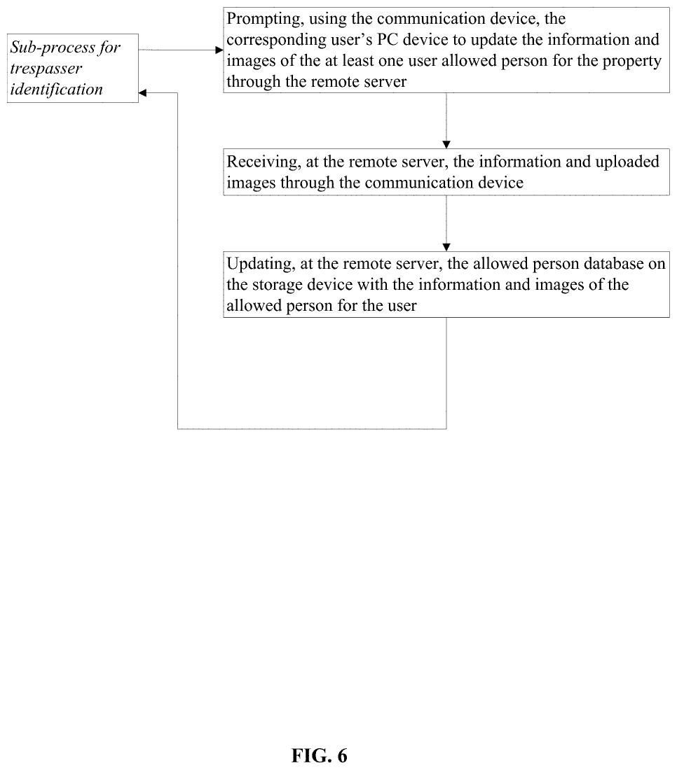

As can be seen in FIG. 6, in another embodiment of the present invention, the method prompts, using the communication device 202, the corresponding user's PC device 231 to update the information and images of the at least one user allowed person for the property through the remote server 102. Subsequently, the method receives, at the remote server 102, the information and uploaded images through the communication device 202 and updates the user allowed person database 208 on the storage device 203 with the information and images of the allowed person for the user. In some embodiments of the present invention, the at least one image of the at least one user allowed person is transmitted to and used by a security access control office for access control to the property. The security access control office may include, but is not limited to, security access check-in gate, security office, badge check-in gate, fence door access gate, building door access, etc. In other embodiments, the at least one image of the at least one user allowed person is transmitted to and used by a security access control office for access control to a gated community of the property.

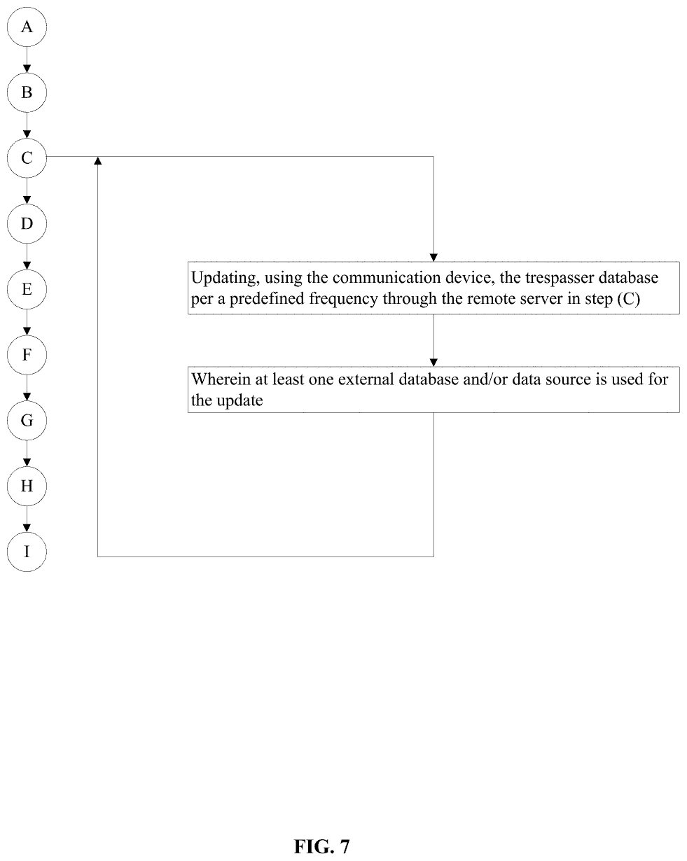

As can be seen in FIG. 7, the method provides a subprocess for updating the trespasser database 207. Specifically, the method updates, using the communication device 202, the trespasser database 207 per a predefined frequency through the remote server in Step C, wherein at least one external database and/or data source is used for the update.

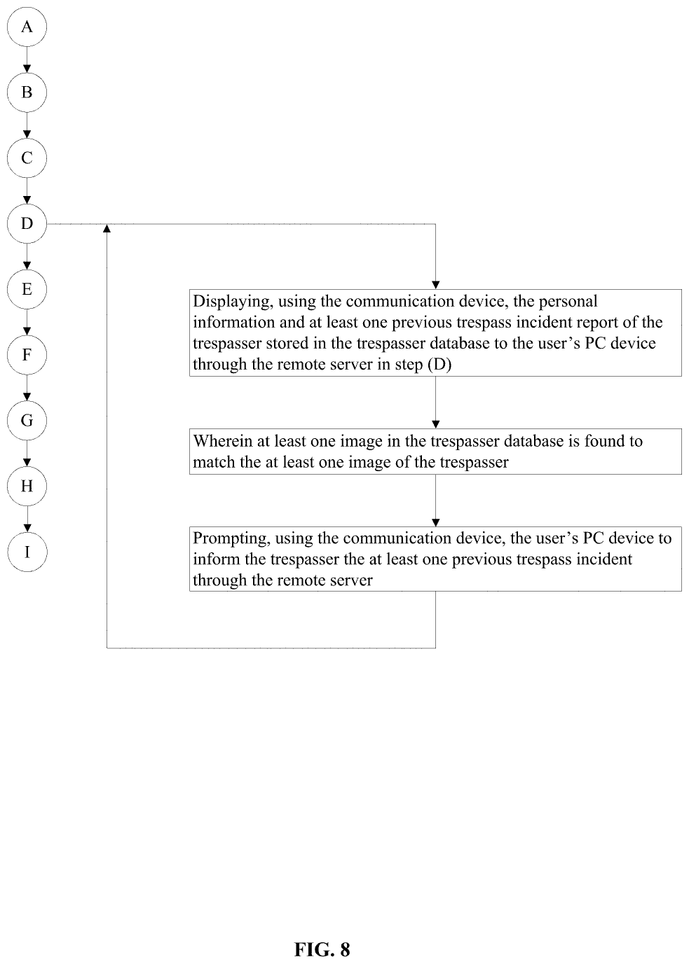

As can be seen in FIG. 8, the method provides information for a non-first-time trespasser. Specifically, the method displays, using the communication device 202, the personal information and at least one previous trespass incident report of the trespasser stored in the trespasser database 207 to the user's PC device 231 through the remote server 102 in Step D, wherein at least one image in the trespasser database 207 is found to match the at least one image of the trespasser. Then, the method prompts, using the communication device 202, the user's PC device 231 to inform the trespasser the at least one previous trespass incident through the remote server 102.

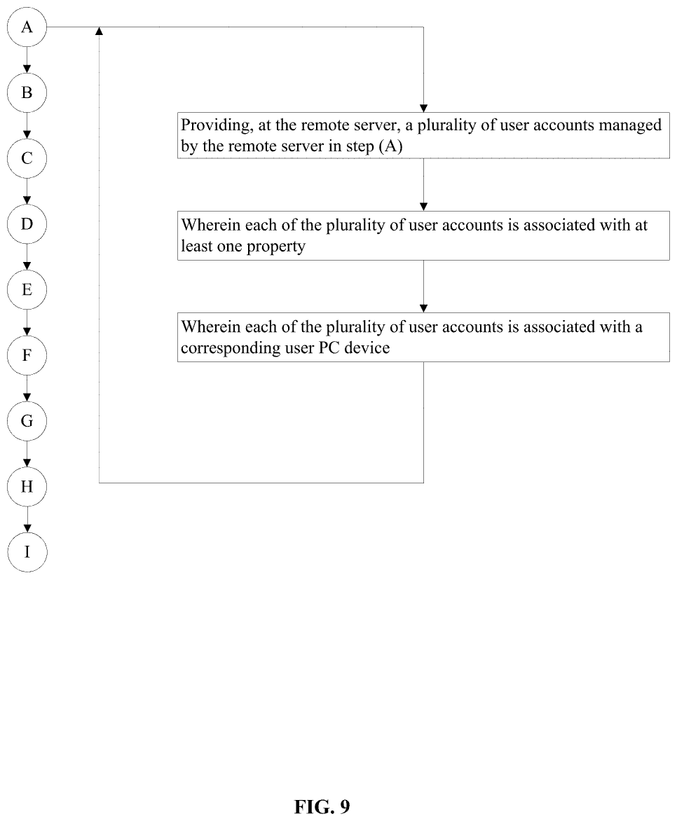

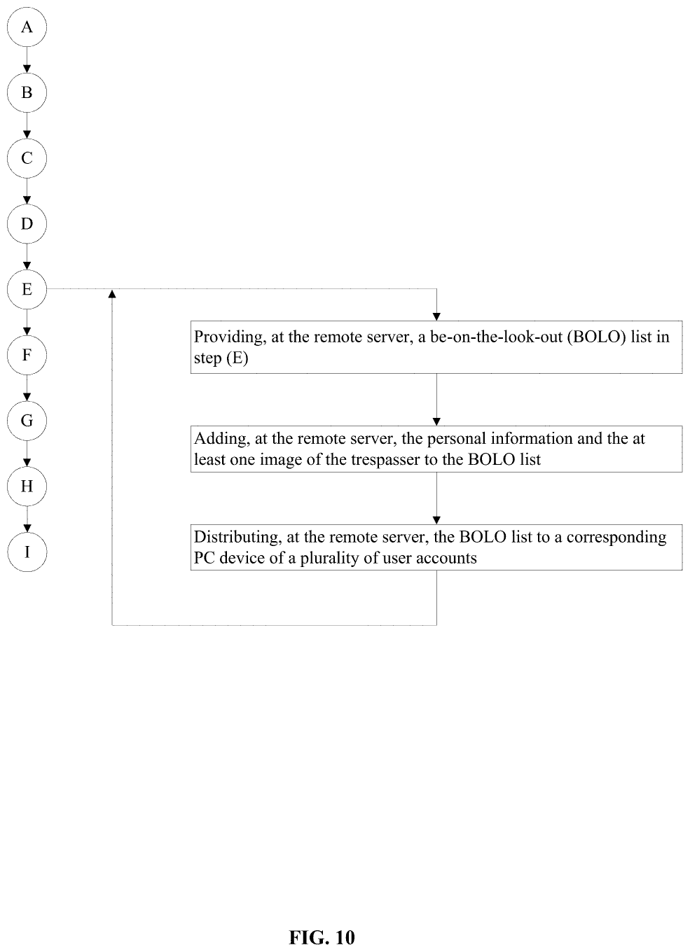

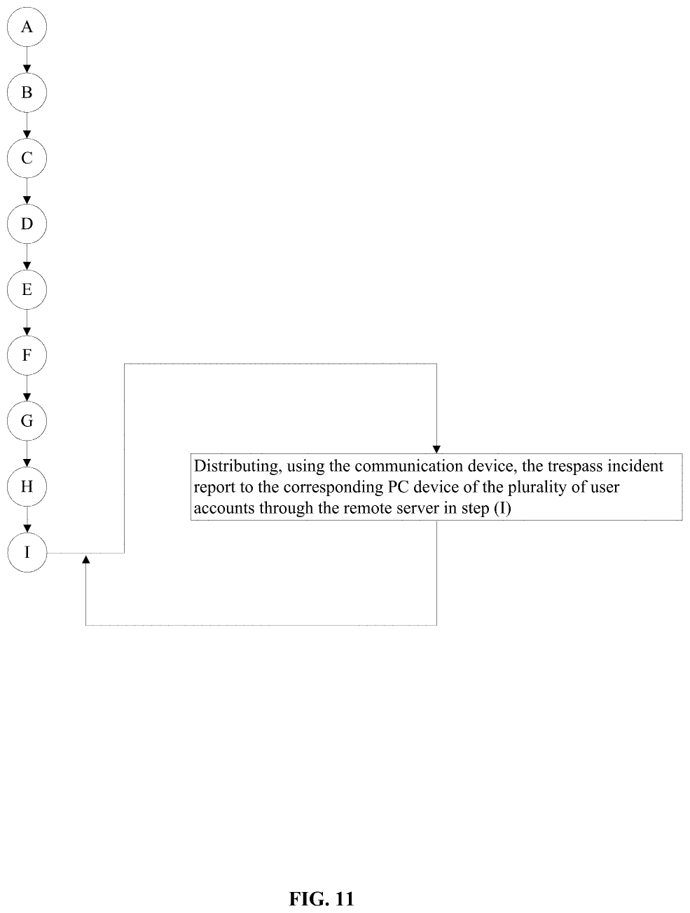

As can be seen in FIG. 9, the method provides a plurality of user accounts. Specifically, the method provides, at the remote server 102, a plurality of user accounts managed by the remote server in Step A, wherein each of the plurality of user accounts is associated with at least one property, and wherein each of the plurality of user accounts is associated with a corresponding user PC device 231. As can be seen in FIG. 10, in some embodiments of the present invention, the method provides, at the remote server 102, a be-on-the-look-out (BOLO) list in Step E and adds, at the remote server 102, the personal information and the at least one image of the trespasser to the BOLO list. Subsequently, the method distributes, at the remote server 102, the BOLO list to the corresponding PC device 231 of the plurality of user accounts. As can be seen in FIG. 11, in other embodiments of the present invention, the method distributes, using the communication device 202, the trespass incident report to the corresponding PC device 231 of the plurality of user accounts through the remote server 102 in Step I.

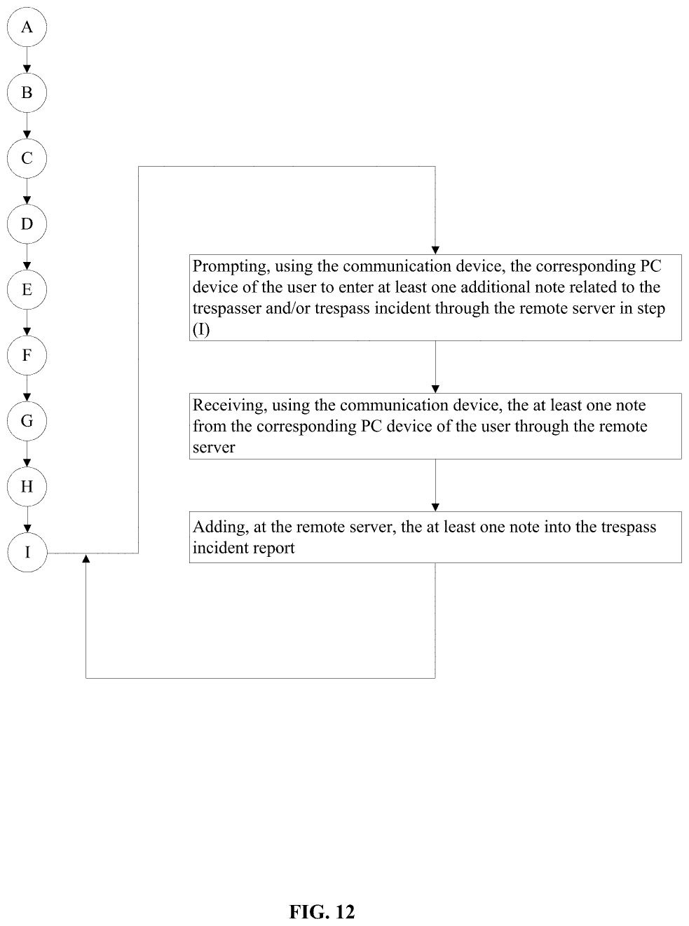

As can be seen in FIG. 12, in some embodiments, the method prompts, using the communication device 202, the corresponding PC device 231 of the user to enter at least one additional note related to the trespasser and/or trespass incident through the remote server 102 in Step I and then receives, using the communication device 202, the at least one note from the corresponding PC device 231 of the user through the remote server 102. Subsequently, the method adds, at the remote server 102, the at least one note into the trespass incident report.

As can be seen in FIG. 13, a system consistent with the embodiments of the present invention may include a computing device or a cloud service, such as the computing device 1300. In a basic configuration, the computing device 1300 may include at least one processor 1302 (201) and a system memory 1304. Depending on the configuration and type of the computing device 1300, a system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image-processing module, machine learning module and/or image classifying module. Furthermore, embodiments of the disclosure may be practiced in conjunction with a graphics library, other operating systems, or any other application program and is not limited to any particular application or system. This basic configuration as can be seen in FIG. 13 by those components within a dashed line 1308.

The computing device 1300 may have additional features or functionality. For example, the computing device 1300 may include additional data storage devices 203 (removable and/or non-removable) such as, for example, magnetic disks, optical disks, or tape. Such additional storage is illustrated in FIG. 13 by a removable storage 1309 and a non-removable storage 1310. Computer storage media may include volatile and nonvolatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

The computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer-readable instructions, data structures, program modules, or other data in a modulated data signal, such as a carrier wave or other transport mechanism, and includes any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include sound encoding/decoding applications, machine learning application, acoustic classifiers, etc. Generally, consistent with embodiments of the present invention, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the present invention may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the present invention, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the present invention have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method for facilitating trespass incident reporting, the method comprising the steps of:
(A) scanning, using at least one camera, a trespasser on a user's property with a predefined boundary to acquire at least one trespasser image thereof, wherein the trespasser is identified through comparison with known trespassers;
(B) transmitting, using a communication device, the at least one trespasser image of the trespasser to a remote server;
(C) prompting, using the communication device, a personal computing (PC) device of the user to compare the trespasser with images of trespassers in a trespasser database stored on a storage device;
(D) prompting, using the communication device, the PC device of the user to enter personal information of the trespasser, wherein the trespasser is determined to be a new trespasser with no matching image using comparison through the remote server;
(E) receiving, using the communication device, the personal information of the trespasser from the user's PC device through the remote server, wherein the personal information of the trespasser is saved to the trespasser database;
(F) prompting, using the communication device, the user's PC device to record, using an audio/video recorder, an audio no-trespass warning message presented to the trespasser using an audio player;
(G) presenting, at the audio player, the entire no-trespass warning message to the trespasser, wherein the no-trespass warning message is recorded using the audio/video recorder;
(H) receiving, using the communication device, the recording of the no-trespass warning message presented to the trespasser from the user's PC device through the remote server; and
(I) generating, at the remote server, a trespass incident report, wherein the trespass incident report includes the user's property, the personal information of the trespasser and the recording of the no-trespass warning message, and wherein the trespass incident report is saved to the trespasser database.

2. The method for facilitating trespass incident reporting as claimed in claim 1, wherein the at least one image of the trespasser comprises a video recording.

3. The method for facilitating trespass incident reporting as claimed in claim 1, further comprising:
providing, at the remote server, at least one user allowed person for the property in step (A);
wherein the at least one user allowed person is saved in an allowed person database stored on the storage device;
prompting, using the communication device, the corresponding user's PC device to upload at least one image of the at least one user allowed person; and
receiving, using the communication device, the at least one image of the at least one user allowed person of the property.

4. The method for facilitating trespass incident reporting as claimed in claim 3, further comprising:
sending, using the communication device, the at least one image of the at least one user allowed person to the processor through the remote server;
receiving, at the processor, the at least one image of the at least one user allowed person through the communication device;
comparing, with the PC device, the at least one image of the trespasser with the at least one image of the at least one user allowed person;
wherein the processor is coupled with the at least one camera; and
confirming, at the processor, the identification of the trespasser.

5. The method for facilitating trespass incident reporting as claimed in claim 3, further comprising:
prompting, using the communication device, the corresponding user's PC device to update the information and images of the at least one user allowed person for the property through the remote server;
receiving, at the remote server, the information and uploaded images through the communication device; and
updating, at the remote server, the allowed person database on the storage device with the information and images of the allowed person for the user.

6. The method for facilitating trespass incident reporting as claimed in claim 3, wherein the at least one image of the at least one user allowed person is transmitted to and used by a security access control office for access control to the property.

7. The method for facilitating trespass incident reporting as claimed in claim 3, wherein the at least one image of the at least one user allowed person is transmitted to and used by a security access control office for access control to a gated community of the property.

8. The method for facilitating trespass incident reporting as claimed in claim 1, further comprising:
displaying, using the communication device, the personal information and at least one previous trespass incident report of the trespasser stored in the trespasser database to the user's PC device through the remote server in step (C);
wherein at least one image in the trespasser database is found to match the at least one image of the trespasser; and
prompting, using the communication device, the user's PC device to inform the trespasser the at least one previous trespass incident through the remote server.

9. The method for facilitating trespass incident reporting as claimed in claim 1, further comprising:
providing, at the remote server, a plurality of user accounts managed by the remote server in step (A);
wherein each of the plurality of user accounts is associated with at least one property; and
wherein each of the plurality of user accounts is associated with a corresponding user PC device.

10. The method for facilitating trespass incident reporting as claimed in 9, further comprising:
providing, at the remote server, a be-on-the-look-out (BOLO) list in step (D);
adding, at the remote server, the personal information and the at least one image of the trespasser to the BOLO list; and
distributing, at the remote server, the BOLO list to the corresponding PC device of the plurality of user accounts.

11. The method for facilitating trespass incident reporting as claimed in claim 9, further comprising:
distributing, using the communication device, the trespass incident report to the corresponding PC device of the plurality of user accounts through the remote server in step (H).

12. The method for facilitating trespass incident reporting as claimed in claim 1, further comprising:
updating, using the communication device, the trespasser database per a predefined frequency through the remote server in step (C); and
wherein at least one external database and/or data source is used for the update.

13. The method for facilitating trespass incident reporting as claimed in claim 1, further comprising:
prompting, using the communication device, the corresponding PC device of the user to enter at least one additional note related to the trespasser and/or trespass incident through the remote server in step (H);
receiving, using the communication device, the at least one note from the corresponding PC device of the user through the remote server; and
adding, at the remote server, the at least one note into the trespass incident report.

14. A system for facilitating trespass incident reporting comprising:
at least one camera;
a processor;
a remote server;
a communication device;
a storage device;
at least one application program interface (API) having software instructions that are saved in the storage device and cause the remote server and the processor to perform operations including:
(J) scanning, using at least one camera, a trespasser on a user's property with a predefined boundary to acquire at least one trespasser image thereof, wherein the trespasser is identified through comparison with known trespassers;
(K) transmitting, using a communication device, the at least one trespasser image of the trespasser to a remote server;
(L) prompting, using the communication device, a personal computing (PC) device of the user to compare the trespasser with images of trespassers in a trespasser database stored on a storage device;
(M) prompting, using the communication device, the PC device of the user to enter personal information of the trespasser, wherein the trespasser is determined to be a new trespasser with no matching image;
(N) receiving, using the communication device, the personal information of the trespasser from the user's PC device through the remote server, wherein the personal information of the trespasser is saved to the trespasser database;
(O) prompting, using the communication device, the user's PC device to record, using an audio/video recorder, an audio no-trespass warning message presented to the trespasser using an audio player;
(P) presenting, at the audio player, the entire no-trespass warning message to the trespasser, wherein the no-trespass warning message is recorded using the audio/video recorder;
(Q) receiving, using the communication device, the recording of the no-trespass warning message presented to the trespasser from the user's PC device through the remote server; and
(R) generating, at the remote server, a trespass incident report, wherein the trespass incident report includes the user's property, the personal information of the trespasser and the recording of the no-trespass warning message, and wherein the trespass incident is saved to the trespasser database.

15. The system for facilitating trespass incident reporting as claimed in claim 14, further comprising:
providing, at the remote server, at least one user allowed person for the property in step (I);
wherein the at least one user allowed person is saved in an allowed person database stored on the storage device;
prompting, using the communication device, the corresponding user's PC device to upload at least one image of the at least one user allowed person; and
receiving, using the communication device, the at least one image of the at least one user allowed person of the property.

16. The system for facilitating trespass incident reporting as claimed in claim 15, further comprising:
sending, using the communication device, the at least one image of the at least one user allowed person to the processor through the remote server;
receiving, at the processor, the at least one image of the at least one user allowed person through the communication device;
comparing, at the processor, the at least one image of the trespasser with the at least one image of the at least one user allowed;
wherein the processor is connected with the at least one camera; and
confirming, at the processor, the identification of the trespasser.

17. The system for facilitating trespass incident reporting as claimed in claim 15, further comprising:
prompting, using the communication device, the corresponding user's PC device to update the information and images of the at least one user allowed person for the property through the remote server;
receiving, at the remote server, the information and uploaded images through the communication device; and
updating, at the remote server, the allowed person database on the storage device with the information and images of the allowed person for the user.

18. The system for facilitating trespass incident reporting as claimed in claim 15, wherein the at least one image of the at least one user allowed person is transmitted to and used by a security access control office for access control to the property.

19. The system for facilitating trespass incident reporting as claimed in claim 15, wherein the at least one image of the at least one user allowed person is transmitted to and used by a security access control office for access control to a gated community of the property.

20. The system for facilitating trespass incident reporting as claimed in claim 14, further comprising:
displaying, using the communication device, the personal information and at least one previous trespass incident report of the trespasser stored in the trespasser database to the user's PC device through the remote server in step (K);
wherein at least one image in the trespasser database is found to match the at least one image of the trespasser is found; and
prompting, using the communication device, the user's PC device to inform the trespasser the at least one previous trespass incident through the remote server.

21. The system for facilitating trespass incident reporting as claimed in claim 14, further comprising:
providing, at the remote server, a plurality of user accounts managed by the remote server in step (I);
wherein each of the plurality of user accounts is associated with at least one property; and
wherein each of the plurality of user accounts is associated with a corresponding user PC device.

22. The system for facilitating trespass incident reporting as claimed in claim 21, further comprising:
providing, at the remote server, a be-on-the-look-out (BOLO) list in step (D);
adding, at the remote server, the personal information and the at least one image of the trespasser to the BOLO list; and
distributing, at the remote server, the BOLO list to the corresponding PC device of the plurality of user accounts.

23. The system for facilitating trespass incident reporting as claimed in claim 21, further comprising:
distributing, using the communication device, the trespass incident report to the corresponding PC device of the plurality of user accounts through the remote server in step (P).

24. The system for facilitating trespass incident reporting as claimed in claim 14, further comprising:
updating, using the communication device, the trespasser database per a predefined frequency through the remote server in step (J); and
wherein at least one external database and/or data source is used for the update.

25. The system for facilitating trespass incident reporting as claimed in claim 14, further comprising:
prompting, using the communication device, the corresponding PC device of the user to enter at least one additional note related to the trespasser and/or trespass incident through the remote server in step (P);
receiving, using the communication device, the at least one note from the corresponding PC device of the user through the remote server; and
adding, at the remote server, the at least one note into the trespass incident report.
